(19) United States
(12) Patent Application Publication
(10) Pub. No.: US 2016/0216771 A1
(43) Pub. Date: Jul. 28, 2016

(54) IMAGE PROJECTING DEVICE HAVING WIRELESS CONTROLLER AND IMAGE PROJECTING METHOD THEREOF

(71) Applicant: NATIONAL TSING HUA UNIVERSITY, HSINCHU (TW)

(72) Inventors: TAI LIANG CHEN, TAICHUNG CITY (TW); CHUN CHIH WANG, TAIPEI CITY (TW); CHI EN WU, NEW TAIPEI CITY (TW); JENQ KUEN LEE, HSINCHU (TW)

(21) Appl. No.: 14/694,364

(22) Filed: Apr. 23, 2015

(30) Foreign Application Priority Data
Jan. 26, 2015 (TW) 104102484

(51) Int. Cl. G06F 3/01; G06F 3/0483; G06F 3/0484; G09G 3/00; G06F 3/033

(52) U.S. Cl. CPC G06F 3/017; G09G 3/002; G06F 3/033; G06F 3/04845; G06F 3/0483; G09G 2370/16

(57) ABSTRACT

A projecting device includes a wireless controller configured for wirelessly detecting a gesture and accordingly generating a wireless signal; and a projector configured for receiving the wireless signal and accordingly controlling a projection image projected by the projector.

### TECHNICAL FIELD

The present disclosure relates to an image projecting device having wireless controller and an image projecting method thereof, and particularly to an image projecting device, which is controlled by wirelessly detecting a user's gesture, and an image projecting method thereof.

### DISCUSSION OF THE BACKGROUND

A conventional image projecting device is primarily controlled by a handheld remote control. The image projecting device is controlled to perform different operations by a user through pressing different buttons on the handheld remote control. Therefore, during a presentation, when a speaker switches different functions of the image projecting device, the speaker has to pause the presentation in order to find the corresponding buttons, thus affecting the quality of the presentation. Further, in order to control the image projecting device at any time, the speaker has to hold the remote control the entire time during the presentation, such that the body language of the speaker is limited, and the remote control becomes a burden to the speaker.

This “Discussion of the Background” section is provided for background information only. The statements in this “Discussion of the Background” are not an admission that the subject matter disclosed in this “Discussion of the Background” section constitutes prior art to the present disclosure, and no part of this “Discussion of the Background” section may be used as an admission that any part of this application, including this “Discussion of the Background” section, constitutes prior art to the present disclosure.

### SUMMARY

According to a first embodiment, an image projecting device including a wireless controller and a projector are disclosed. The wireless controller is configured for wirelessly detecting a gesture and accordingly generating a wireless signal. The projector is configured for receiving the wireless signal and accordingly controlling an image projected by the projector.

According to a second embodiment, an image projecting method is disclosed. The image projecting method includes wirelessly detecting a gesture and accordingly generating a wireless signal; and receiving the wireless signal and accordingly controlling a projection image projected by a projector.

According to a third embodiment, a wireless controller is disclosed. The wireless controller includes a sensing unit, a processing unit and a wireless signal outputting unit. The sensing unit is configured for wirelessly sensing a gesture and accordingly generating a sensing signal. The processing unit is configured for generating a gesture feature signal according to the sensing signal. The wireless signal outputting unit is configured for generating a wireless signal according to the gesture feature signal.

According to the above embodiments, a variation of a gesture is wirelessly detected, and the projector is controlled to perform various projecting actions. Therefore, a speaker remotely controls a projecting device without holding a remote controller for long time, such that the speaker can concentrate on the presentation. In addition, the wireless controller can be integrated into a conventional remote controller for saving hardware cost of a projecting device.

The foregoing outlines features of several embodiments so that those skilled in the art may better understand the aspects of the present disclosure. Other technical features and advantages constituting claims of the present disclosure are described in the following descriptions. Those skilled in the art should appreciate that they may readily use the present disclosure as a basis for designing or modifying other processes and structures for carrying out the same purposes of the embodiments introduced herein. Those skilled in the art should also realize that such equivalent constructions do not depart from the spirit and scope of the present disclosure, and that they may make various changes, substitutions.

### BRIEF DESCRIPTION OF THE DRAWINGS

Aspects of the present disclosure are best understood from the following detailed description when read with the accompanying figures. Please note that in accordance with the standard practice in the industry, various features are not drawn to scale. In fact, the dimensions of the various features may be arbitrarily increased or reduced for clarity of discussion.

FIG. 1 is a diagram illustrating a projecting system in accordance with an embodiment of the present disclosure.

FIG. 2 is a diagram illustrating a wireless controller in accordance with an embodiment of the present disclosure.

FIG. 3 is a diagram illustrating a projector in accordance with an embodiment of the present disclosure.

FIG. 4 is a diagram illustrating a projecting system performing a clean-handwriting operation in accordance with an embodiment of the present disclosure.

FIG. 5 is a diagram illustrating a gesture for holding a tool in accordance with an embodiment of the present disclosure.

FIG. 6 is a diagram illustrating a gesture of a rotating tool in accordance with an embodiment of the present disclosure.

FIG. 7 is a flowchart illustrating a projecting system performing a jump page operation in accordance with an embodiment of the present disclosure.

FIG. 8 is a diagram illustrating the detection of a number of fingers in accordance with an embodiment of the present disclosure.

FIG. 9 is a flowchart illustrating a projecting system performing a screen adjustment operation in accordance with an embodiment of the present disclosure.

FIG. 10 is a diagram illustrating a gesture of a palms-together motion in accordance with an embodiment of the present disclosure.

FIG. 11 is a diagram illustrating a gesture of a palms-apart motion in accordance with an embodiment of the present disclosure.

FIG. 12 is a diagram illustrating a gesture of two fists together and separate apart in accordance with an embodiment of the present disclosure.

FIG. 13 is a diagram illustrating a projecting system performing a change page operation in accordance with an embodiment of the present disclosure.

FIG. 14 is a diagram illustrating a gesture of a forward change page motion in accordance with an embodiment of the present disclosure.

FIG. 15 is a diagram illustrating a projecting system performing an image adjustment operation in accordance with an embodiment of the present disclosure.

FIG. 16 is a diagram illustrating a gesture of a forward motion and a backward motion in accordance with an embodiment of the present disclosure.

FIG. 17 is a diagram illustrating a projecting system performing an indicative pen operation in accordance with an embodiment of the present disclosure.

FIG. 18 is a diagram illustrating a gesture of the motion of a laser pen in accordance with an embodiment of the present disclosure.

FIG. 19 is a diagram illustrating the switching between a motion of a painting pen and a motion of a laser pen according to the number of fingers in accordance with an embodiment of the present disclosure.

### DETAILED DESCRIPTION

In order for one with ordinary skill in the art to thoroughly understand the present disclosure, the following descriptions provide detailed steps and structures. Obviously, the implementation of the present disclosure is not limited to the specific detail known by one with common knowledge in the art. On the other hand, well-known structures or steps are not described in the detail of the description, so as to avoid unnecessary limitations to the present disclosure. Preferred embodiments of the present disclosure are described in detail as follows; however, in addition to these detailed descriptions, the present disclosure can also be widely applied in other embodiments. The scope of the present disclosure is no limited to the descriptions of embodiments, but is defined in claims.

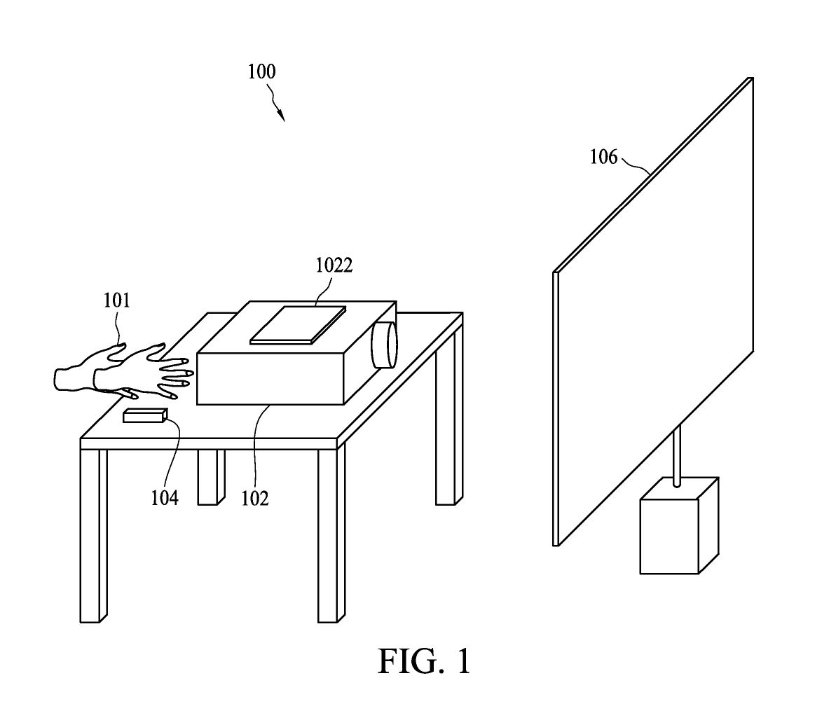

FIG. 1 is a diagram illustrating a projecting system 100 in accordance with an embodiment of the present disclosure. The projecting system 100 is an interactive gesture projecting system, which is a multimedia projecting environment capable of detecting interactive gestures, combining with wireless internet, and freely and remotely operating protection content. The projecting system 100 includes a projector 102, a wireless controller 104 and a projection screen 106. The projector 102 can be disposed on a desk or fixed on a ceiling. The wireless controller 104 is a portable controller, and can be placed at any proper position for detecting a user's gesture so as to control the projector 102. Alternatively, the projector 102 can be controlled by a user by pressing buttons on the wireless controller 104. Therefore, according to the present disclosure, the projector 102 is not only controlled by the buttons on the wireless controller 104 but also controlled by wireless signals generated from a user's gestures through a wireless detection. When the wireless controller 104 is a button-type wireless remote controller, signals are transmitted between the wireless controller 104 and the projector 102 via infrared light. When the wireless controller 104 is configured for wirelessly detecting a user's gestures to generate a wireless signal to the projector 102, signals can be transmitted between the wireless controller 104 and the projector 102 via any wireless internet protocol, such as Wi-Fi internet protocol or Bluetooth communication protocol. Please note that the wireless controller 104 of the present disclosure is not limited to having both the above functions. In another embodiment, the wireless controller 104 can control the projector 102 only by wirelessly detecting a user's gestures to generate a wireless signal.

In addition, in the preferred embodiment, the projector 102 is controlled by the wireless signal transmitted from the wireless controller 104, and further includes a touch panel 1022. A user interface of the touch panel 1022 is configured for receiving a touch instruction from a user. The user can directly contact the touch panel 1022 of the projector 102 for controlling the operation of the projector 102. In one preferred embodiment, the projector 102 is operated under an embedded operating system, such as Android operating system, so that the projector 102 can receive a wireless signal and a touch signal for performing an interactive function. Therefore, the projecting system 100 of the present disclosure can be used in interactive multimedia applications, such as a slide presentation, a multimedia player, system setup and operations of the projector at a meeting, and the like.

The technical feature of the wireless controller 104 for wirelessly detecting a user's gestures to generate a wireless control signal is emphasized in the following paragraph. As previously mentioned, the wireless controller 104 and the projector 102 constitute a projecting device. The wireless controller 104 is configured for wirelessly detecting a gesture 101 so as to generate a wireless signal Sr. The projector 102 is configured for controlling a projection image projected by the projector 102 according to the wireless signal Sr. There is a wireless internet, such as Wi-Fi internet or Bluetooth internet, connected between the wireless controller 104 and the projector 102. Therefore, the wireless signal Sr can be a Wi-Fi signal or a Bluetooth signal.

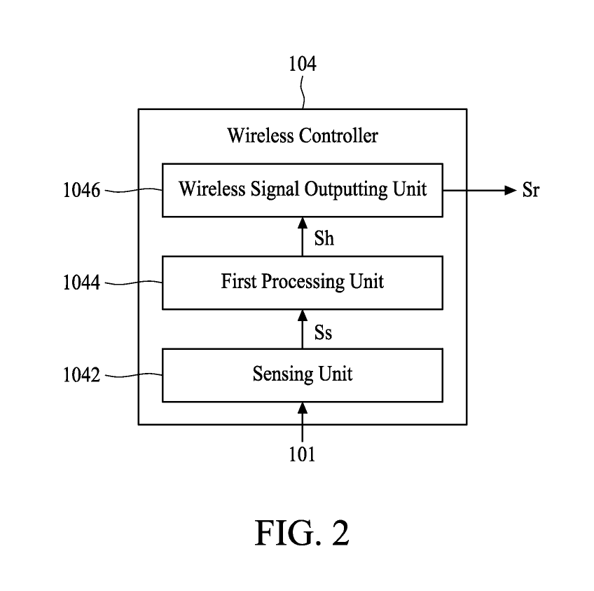

FIG. 2 is a diagram illustrating a wireless controller 104 according to an embodiment of the present disclosure. The wireless controller 104 includes a sensing unit 1402, a first processing unit 1044 and a wireless signal outputting unit 1046. When the wireless controller 104 and the projector 102 are wirelessly connected, the wireless controller 104 can be optionally placed at any position. The sensing unit 1042 is configured for sensing a gesture 101 to generate a sensing signal Ss. In one preferred embodiment, when a user's gesture 101 is disposed just above the wireless controller 104, the sensing unit 1042 can sense the change of the gesture more precisely. The first processing unit 1044 is configured for generating a gesture feature signal Sh according to the sensing signal Ss. Further, the gesture feature signal Sh includes data about features of one or two palms of the user. The wireless signal outputting unit 1046 is configured to generate a wireless signal Sr to the projector 102 according to the gesture feature signal Sh.

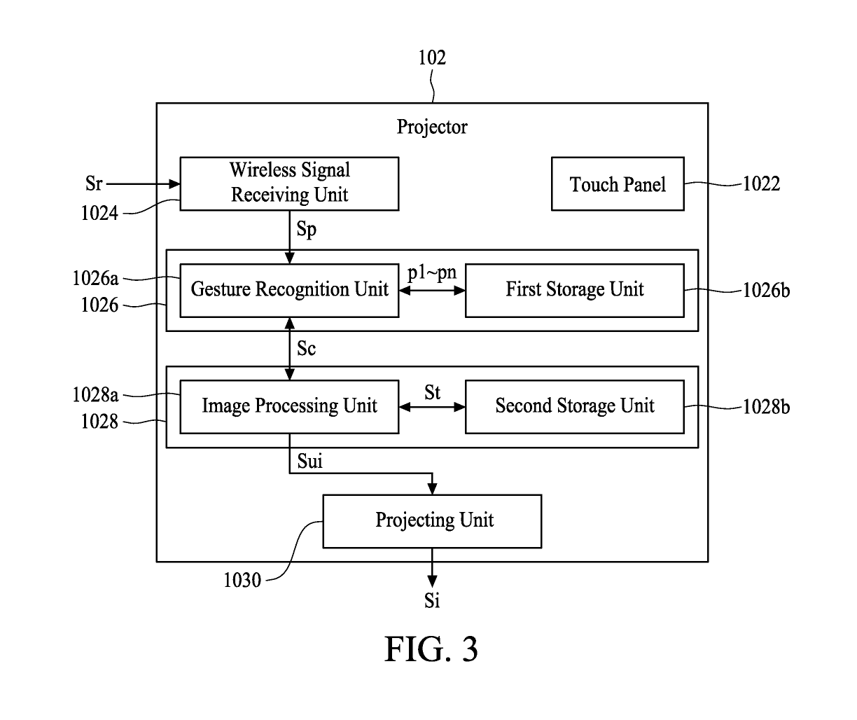

FIG. 3 is a diagram illustrating a projector 102 according to an embodiment of the present disclosure. In addition to the touch panel 1022, the projector 102 further includes a wireless signal receiving unit 1024, a second processing unit 1026, a third processing unit 1028 and a projecting unit 1030. The wireless signal receiving unit 1024 is configured for receiving a wireless signal Sr to generate a reception type Sp. The wireless signal receiving unit 1024 can be configured for receiving a Wi-Fi signal or a Bluetooth signal. The second processing unit 1026 is configured for receiving the reception type Sp to generate a control signal Sc.

The second processing unit 1026 is performed under an embedded operating system, such as Android operating system. The second processing unit 1026 includes a gesture recognition unit 1026a and a first storage unit 1026b. The gesture recognition unit 1026a is configured for identifying whether the reception type Sp is one of a plurality of predetermined reception types p1-pn, so as to generate a control signal Sc. The first storage unit 1026b is configured for storing the plurality of predetermined reception types p1-pn. In accordance with the preferred embodiment of the present disclosure, if the reception type Sp is substantially the same as a target type, which is one of the plurality of the reception types p1-pn, the gesture recognition unit 1026a generates a control signal Sc according to the target type. The plurality of predetermined reception types p1-pn can be stored in the first storage unit 1026b by a user. In one preferred embodiment, the gesture recognition unit 1026a is used for analyzing the gesture corresponding to the reception type Sp, and identifying whether the gesture is one of gestures corresponding to the plurality of predetermined reception types p1-pn respectively. Please note that the above operation of the second processing unit 1026 is one implementation of the second processing unit 1026 of the present disclosure, and the present disclosure is not limited thereto. Any method for identifying the reception type Sp falls within the scope of the present disclosure.

The third processing unit 1028 further generates an updated image signal Sui according to the control signal Sc. The third processing unit 1028 includes an image processing unit 1028a and a second storage unit 1028b. The image processing unit 1028a is configured for performing an image processing operation on a current image signal according to the control signal Sc, and accordingly generating an updated image signal Sui. The second storage unit 1028b is configured for storing at least one temporarily stored signal St, which is generated by the image processing unit 1028a while performing the image processing operation. The projection unit 1030 is configured for projecting a projection image Si according to the updated image signal Sui.

Please note that in one embodiment, the second processing unit 1026 and the third processing unit 1028 are integrated into a processor operated by an embedded operating system for facilitating computing speed. FIG. 3 shows different function blocks (1026a, 1026b, 1028a, 1028b) of the processor for describing the detailed operations of the projector 102 of the present disclosure. In addition, the gesture recognition unit 1026a and the image processing unit 1028a shown in FIG. 3 can be implemented by software, wherein the software is stored in any storage medium in the projector 102.

According to one preferred embodiment of the present disclosure, the plurality of predetermined reception types p1-pn at least includes a clean-handwriting type p1, a jump page type p2, a screen adjustment type p3, a change page type p4, an image adjustment type p5 and an indicative pen type p6. Therefore, the wireless controller 104 of the present disclosure can identify at least the above six different types of gestures, and generate corresponding wireless signals Sr to the projector 102. After receiving the wireless signals Sr, the projector performs corresponding projections. In other words, the wireless signal Sr generated by the wireless controller 104 includes feature data of the detected gesture, and the wireless signal Sr is decoded and analyzed by the projector 102 so as to perform the corresponding projection.

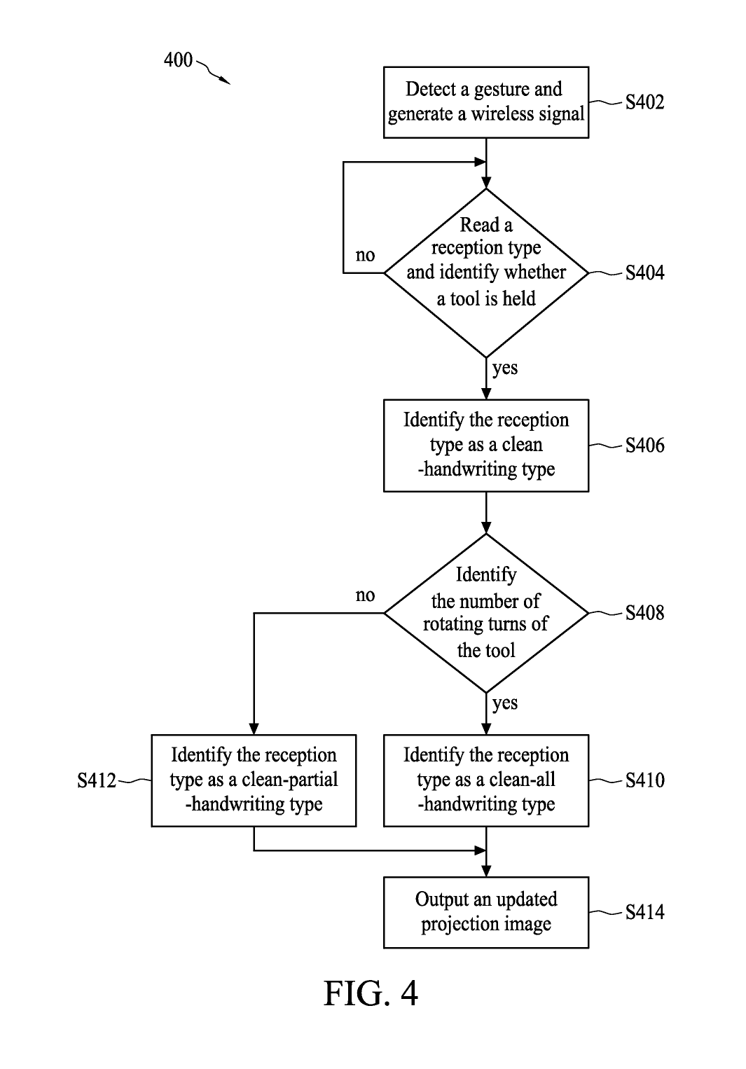

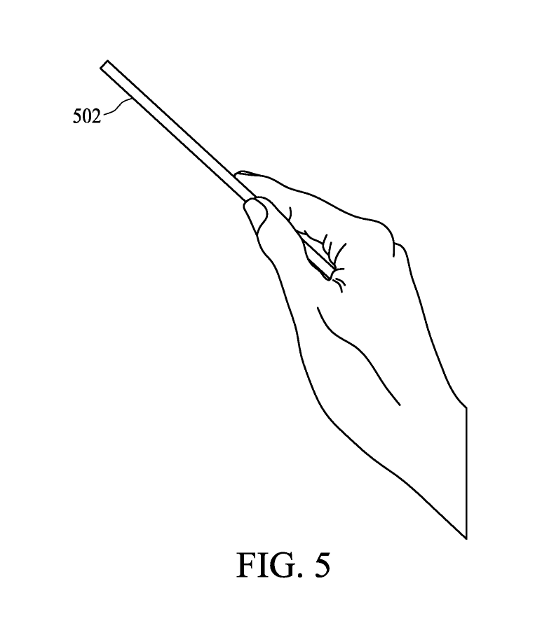

FIG. 4 is a diagram illustrating a projecting system 100 preforming a clean handwriting operation 400 in accordance with an embodiment of the present disclosure. Referring to FIG. 4, in step S402, the wireless controller 104 detects a gesture and generates a wireless signal Sr to the projector 102. In step S404, the projector 102 reads the reception type Sp and identifies whether a tool is held in the gesture. If a tool is held in the gesture, step S406 is performed. If there is no tool held in the gesture, step S404 is performed. In step S406, the projector identifies the reception type Sp as the clean-handwriting type p1 (i.e. the target type), and thus the projector 102 enters a clean-handwriting mode. FIG. 5 is a diagram illustrating a gesture for holding a tool 502 in accordance with the present disclosure. The tool 502 can be any object similar to a pencil.

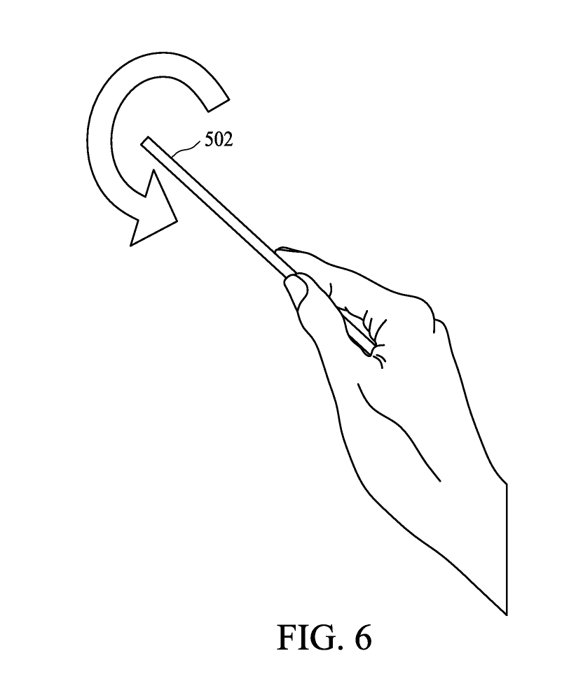

In step S408, the projector 102 identifies the number of rotating turns of the tool. If the number of rotating turns of the tool reaches a specific number, step S410 is performed. If the number of rotating turns of the tool fails to reach the specific number, step S412 is performed. Please note that the specific number can be set as any integer (for example, 3) or a non-integer. In step S410, the projector 102 identifies the reception type Sp as a clean-all-handwriting type, and accordingly generates a control signal Sc. In step S412, the projector 102 identifies the reception type Sp as a clean-partial-handwriting type, and accordingly generates a control signal Sc. Therefore, in this preferred embodiment, the clean-handwriting type p1 further includes a clean-all-handwriting type and a clean-partial-handwriting type. When the reception type Sp is a clean-all-handwriting type, the image processing unit 1028a is controlled by the control signal Sc so as to clean all handwriting on the current projection screen 106. When the reception type Sp is a clean-partial-handwriting type, the image processing unit 1028a is controlled by the control signal Sc so as to clean partial handwriting on the current projection screen 106. For example, when the reception type Sp is a clean-partial-handwriting type, the image processing unit 1028a only cleans the latest handwriting on the projection screen. In step S414, the projector 102 outputs the updated projection image. FIG. 6 is a diagram illustrating the gesture of the rotating tool 502 according to the present disclosure. Note, the gesture in clockwise rotation and the gesture in counterclockwise rotation are within the scope of the present disclosure.

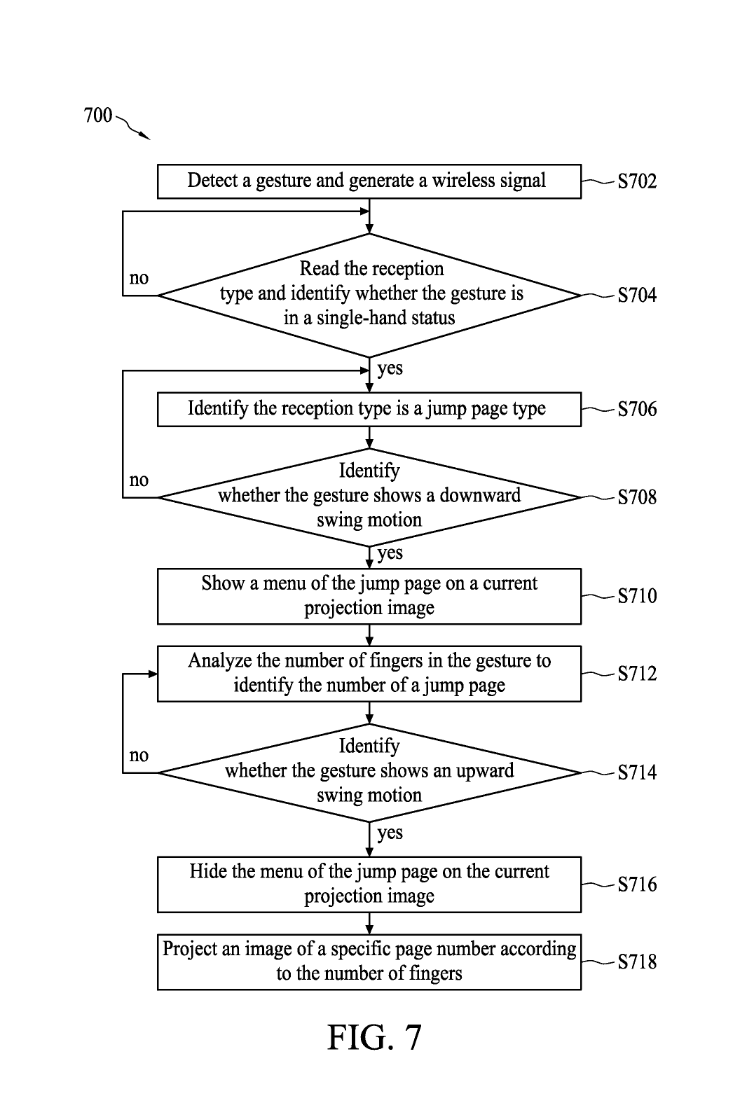

FIG. 7 is a flowchart illustrating a projecting system 100 performing a jump page operation 700 in accordance with an embodiment of the present disclosure. Referring to FIG. 7, in step S702, the wireless controller 104 detects a gesture and generates a wireless signal Sr to the projector 102. In step S704, the projector 102 reads the reception type Sp, and identifies whether the gesture is in a single-hand status. If the gesture is in the single-hand status, step S706 is performed. If the gesture is not in the single-hand status, step S704 is performed.

In step S706, the projector 102 identifies that the reception type Sp is the jump page type p2 (i.e. the target type), and thus the projector 102 enters a jump page mode. In step S708, the projector 102 identifies whether the gesture shows a downward swing motion. If the gesture shows a downward swing motion, step S710 is performed. If the gesture does not show a downward swing motion, step S706 is performed. In step S710, the image processing unit 1028a controls the projecting unit 130 in order to show a menu of the jump page on the current projection image.

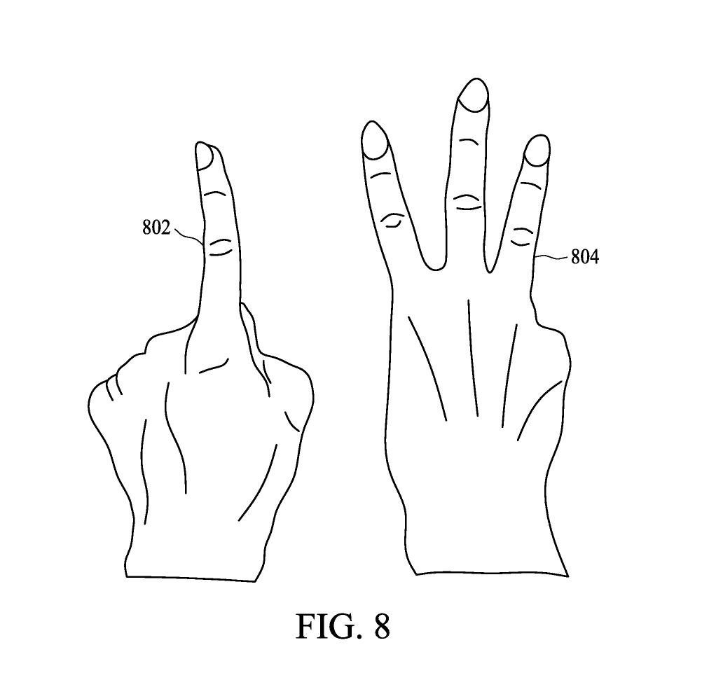

In step S712, the projector 102 analyzes the number of fingers in the gesture so as to identify the number of a jump page. In one preferred embodiment, the number of fingers indicates the number of the jump page or a target pages. FIG. 8 is a diagram illustrating the detection of the number of fingers in accordance with the present disclosure. In this example, the gesture 802 shown on the left side of FIG. 8 indicates “1”, and the gesture 804 shown on the right side of FIG. 8 indicates “3”. Therefore, the number of the jump page or the target number obtained from the projector 102 is 13. When the number of fingers indicates the number of the jump page, the image processing unit 1028a adds the number of the jump page to the current page so as to generate a target image. When the number of fingers is the target number, the projector 102 directly generates the target image of the target number. Please note that the gesture 802 on the left side of FIG. 8 and the gesture 804 on the right side of FIG. 8 can be formed by one hand at different time or directly formed by two hands. When the gesture 802 and the gesture 804 are formed by one hand, the projector 102 would analyze the number of fingers twice so as to obtain the number of the jump page (or the target number), wherein the projector 102 analyzes the gesture 802 to obtain “1” as the digit in tens, and the projector 102 analyzes the gesture 804 to obtain “3” as the digit in ones. Therefore, the number of the jump page (or the target page) obtained by the projector 102 is “13”.

In step S714, the projector 102 identifies whether the gesture shows an upward swing motion. If the gesture shows an upward swing motion, step S716 is performed. If the gesture does not show an upward swing motion, step S712 is performed.

In step S716, the image processing unit 1028a controls the projecting unit 1030 so as to hide the menu of the jump page on the current projection image. In step S718, the image processing unit 1028a controls the projecting unit 1030 according to the number of fingers obtained from step S712 in order to project an image of a specific page number which is the target image.

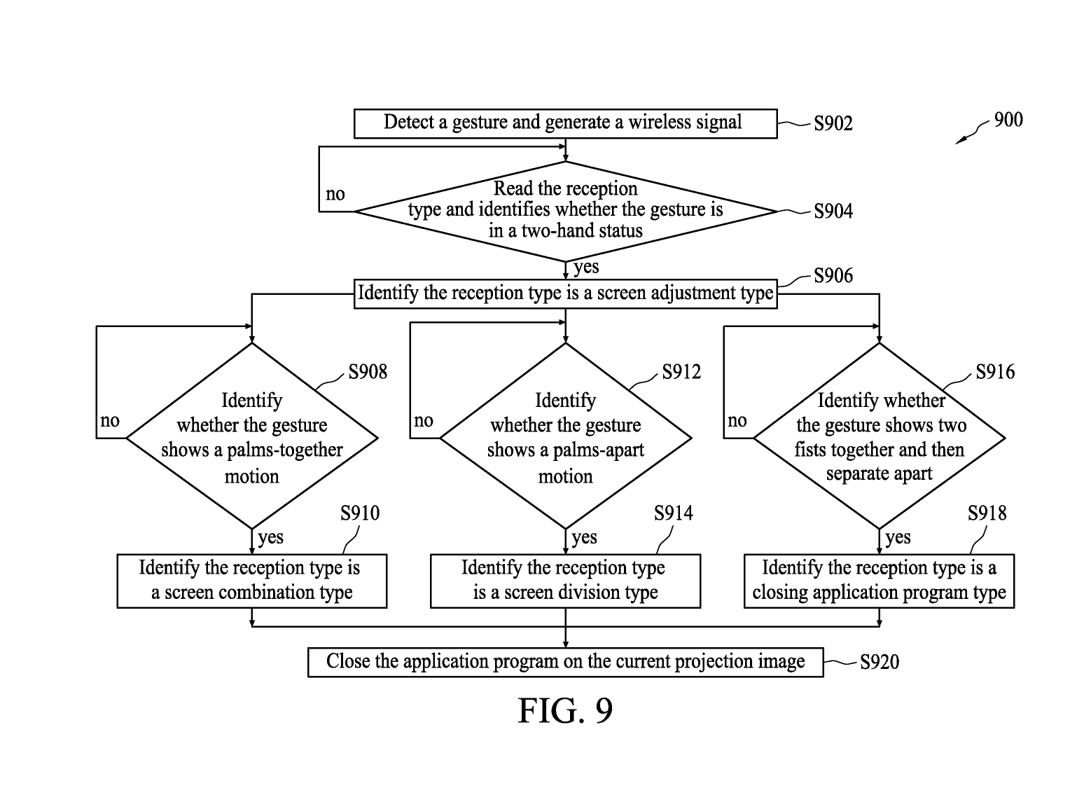

FIG. 9 is a flowchart illustrating a projecting system 100 performing a screen adjustment operation 900 in accordance with an embodiment of the present disclosure. Referring FIG. 9, in step S902, the wireless controller 104 detects a gesture and generates a wireless signal Sr to the projector 102. In step S904, the projector 102 reads the reception type Sp, and identifies whether the gesture is in a two-hand status. If the gesture is in a two-hand status, step S906 is performed. If the gesture is not in a two-hand status, step S904 is performed.

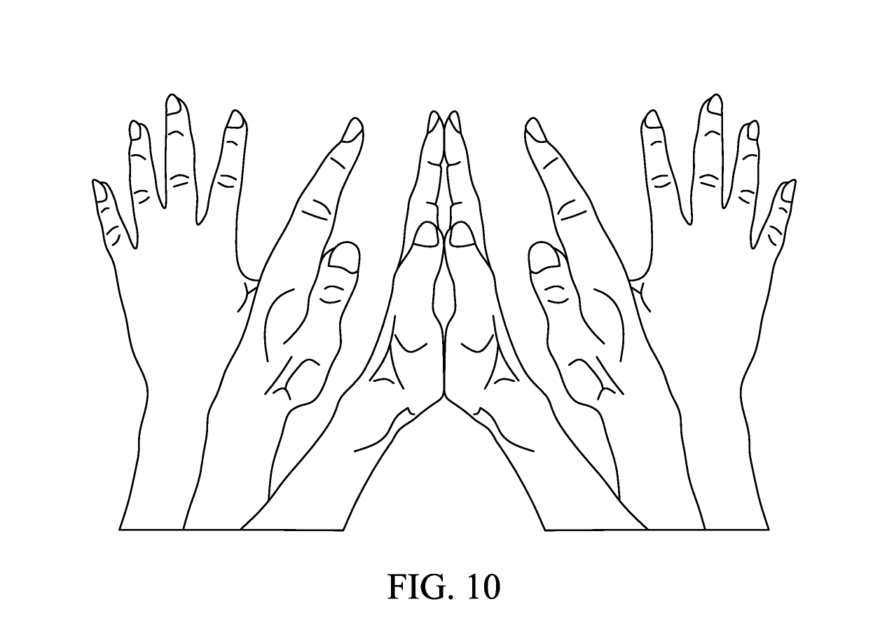

In step S906, the projector 102 identifies that the reception type Sp is a screen adjustment type p3 (i.e. the target type), and thus the projector 102 enters a screen adjustment mode. In step S908, the projector 102 identifies whether the gesture shows a palms-together motion. If the gesture shows a palms-together motion, step S910 is performed. If the gesture does not show a palms-together motion, step S908 is performed. In step S910, the projector 102 identifies that the reception type Sp is a screen combination type, and accordingly generates a control signal Sc. FIG. 10 is a diagram illustrating the gesture of a palms-together motion according to the present disclosure. Further, when the gesture changes from a palms-apart motion to a palms-together motion, the projector 102 combines the current projection image (for example, two sub-images) into a normal projection image (for example, a single image), i.e. step S920.

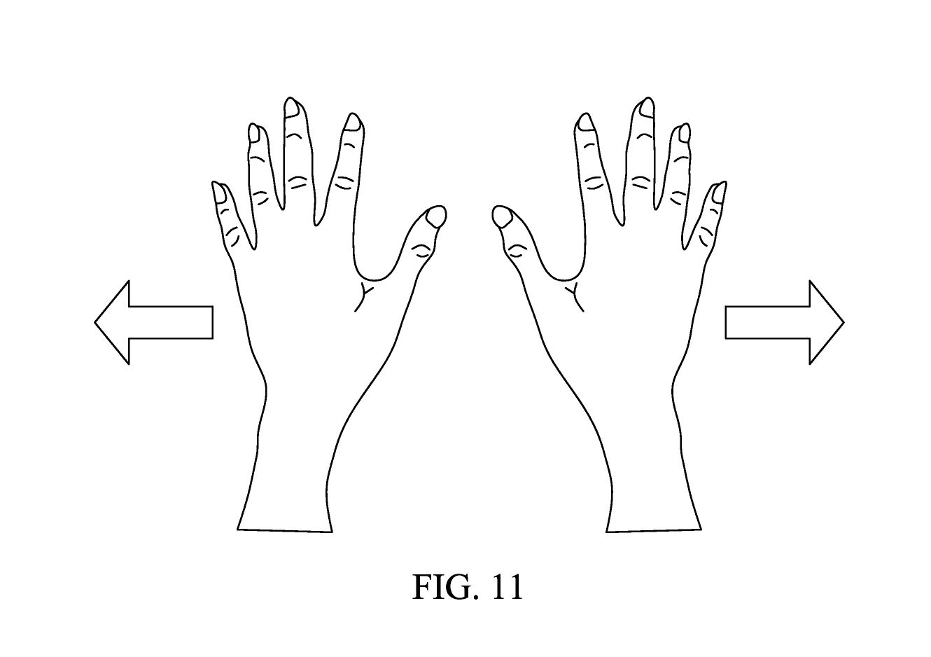

In step S912, the projector 102 identifies whether the gesture shows a palms-apart motion. If the gesture shows a palms-apart motion, step S914 is performed. If the gesture does not show a palms-apart motion, step S912 is performed. In step S914, the projector 102 identifies that the reception type Sp is a screen division type, and accordingly generates a control signal Sc. FIG. 11 is a diagram illustrating the gesture of a palms-apart motion in accordance with the present disclosure. Further, when the gesture shows palms open, and the palms face upward or downward and move away in opposite directions, then the projector 102 divides the current projection image (for example, a single image) into two sub-images, i.e. step S920.

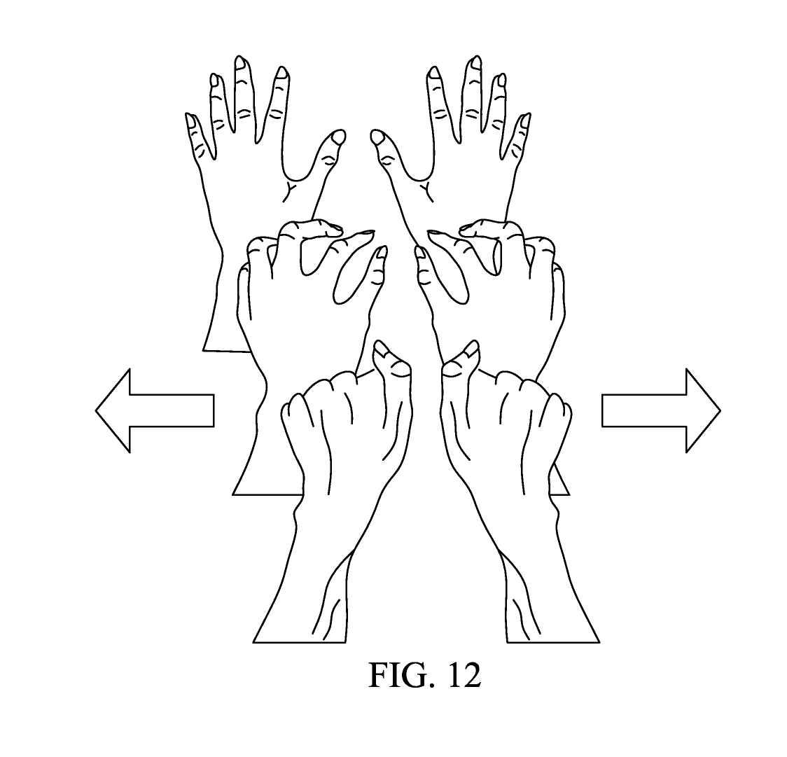

In step S916, the projector 102 identifies whether the gesture shows two fists together and then separate apart. If the gesture shows that two fists together and then separate apart, step S918 is performed. If the gesture does not show two fists together and then separate apart, step S916 is performed. In step S918, the projector 102 identifies the reception type Sp is a closing application program type, and accordingly generates a control signal Sc. FIG. 12 is a diagram illustrating a gesture of a motion of two fists together and then separate apart in accordance with the present disclosure. Further, when the gesture shows two palms open and move downward into fists, and then the two fists swing in opposite directions, the projector 102 closes the application program on the current projection image, i.e. step S920.

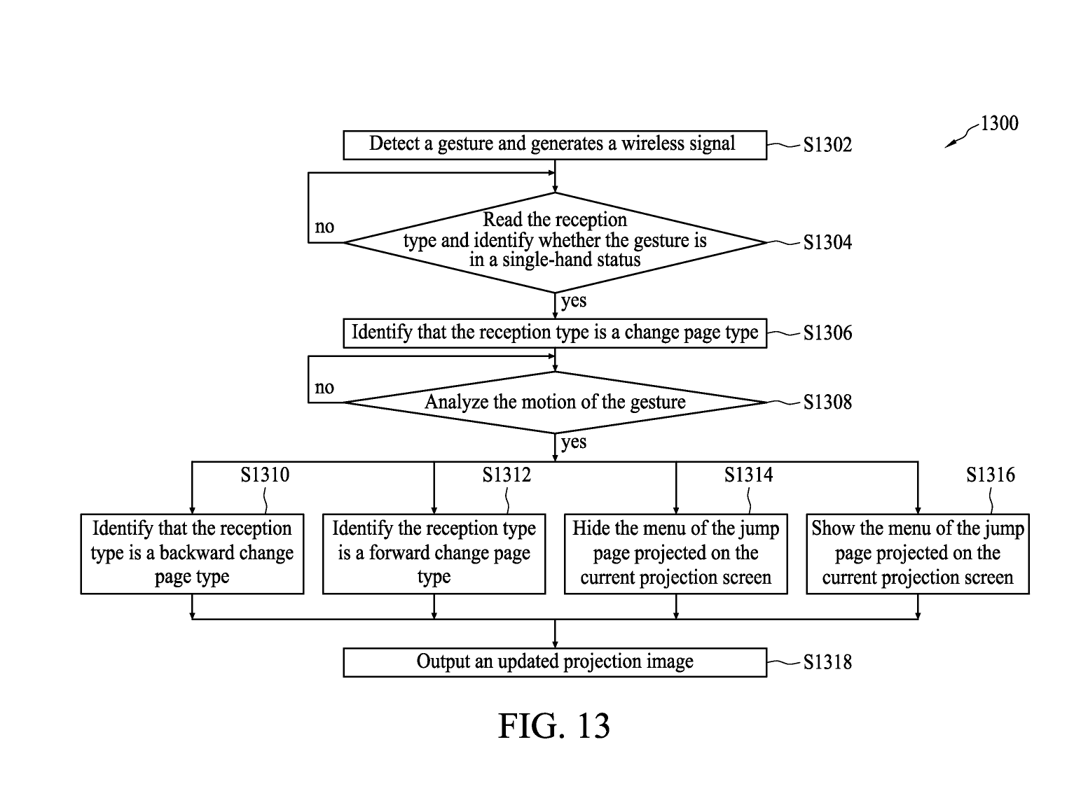

FIG. 13 is a flowchart illustrating a projecting system 100 performing a change page operation 1300 in accordance with the present disclosure. Referring to FIG. 13, in step S1302, the wireless controller 104 detects a gesture and generates a wireless signal Sr to the projector 102. In step S1304, the projector 102 reads the reception type Sp, and identifies whether the gesture is in a single-hand status. If the gesture is in a single-hand status, step S1306 is performed. If the gesture is not in a single-hand status, step S1304 is performed.

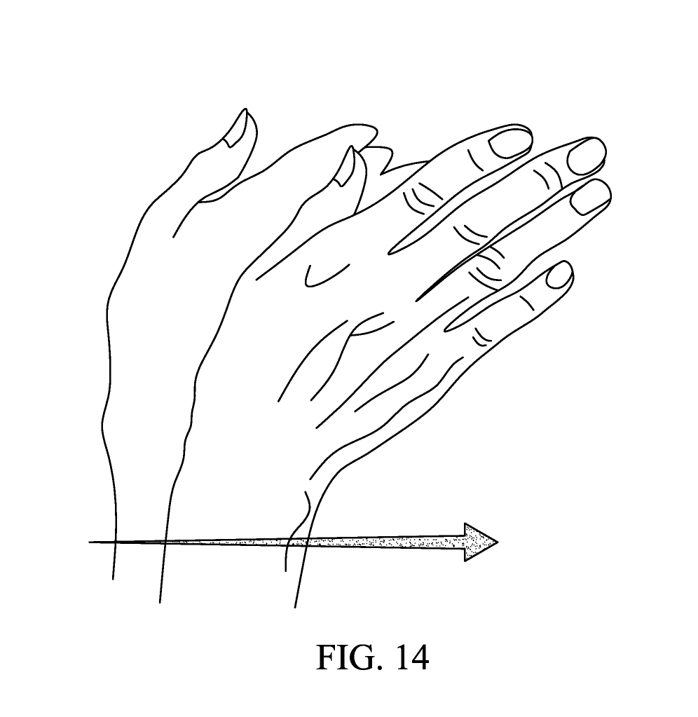

In step S1306, the projector 102 identifies that the reception type Sp is a change page type p4 (i.e. the target type), and thus the projector 102 enters a change page mode. In step S1308, the projector 102 analyzes the motion of the gesture. If the gesture shows a rightward swing motion, step S1310 is performed. In step S1310, the projector 102 identifies that the reception type Sp is a backward change page type, and accordingly generates a control signal Sc. If the gesture shows a leftward swing motion, step S1312 is performed. In step S1312, the projector 102 identifies that the reception type Sp is a forward change page type, and accordingly generates a control signal Sc. Further, when the gesture shows that the palm is open and swings rightward, the projector 102 changes the current projected slide to the next page, i.e. step S1318. When the gesture shows that the palm is open and swings leftward, the projector 102 changes the current projected slide to the previous page, i.e. step S1318. FIG. 14 is a diagram illustrating the gesture of a forward change page motion in accordance with an embodiment of the present disclosure.

If the gesture shows an upward swing motion, step S1314 is performed. In step S1314, the projector 102 hides the menu of the jump page projected on the current projection screen 106, and outputs an updated projection image in step S1318. If the gesture shows a downward swing motion, step S1316 is performed. In step S1316, the projector 102 shows the menu of the jump page projected on the current projection screen 106, and outputs an updated projection image in step S1318.

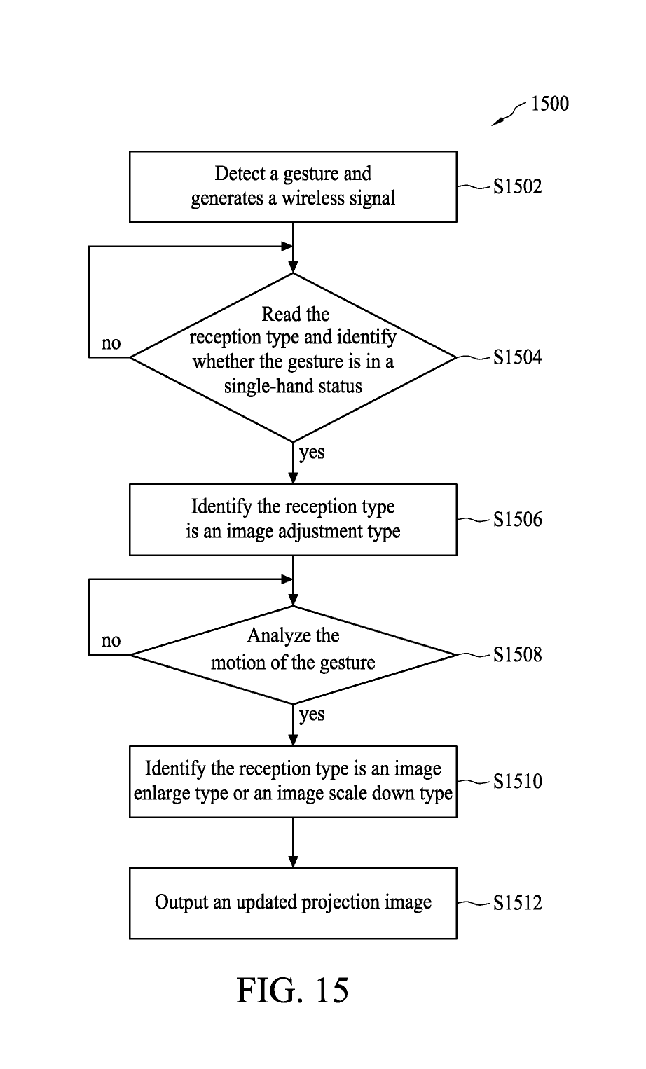

FIG. 15 is a diagram illustrating a projecting system 100 performing an image adjustment operation 1500 in accordance with an embodiment of the present disclosure. Referring to FIG. 15, in step S1502, the wireless controller 104 detects a gesture and generates a wireless signal Sr to the projector 102. In step S1504, the projector 102 reads the reception type Sp, and identifies whether the gesture is in a single-hand status. If the gesture is in a single-hand status, step S1506 is performed. If the gesture is not in a single-hand status, step S1504 is performed.

In step S1506, the projector 102 identifies that the reception type Sp is an image adjustment type p5 (i.e. the target type), and thus the projector 102 enters an image adjustment mode. In step S1508, the projector 102 analyzes the motion of the gesture. If the gesture shows a forward motion or a backward motion, step S1510 is performed. If the gesture does not show a forward motion and a backward motion, step S1508 is performed. In step S1510, the gesture shows a forward motion, the projector 102 identifies that the reception type Sp is an image enlarge type, and accordingly generates a control signal Sc. On the contrary, in step S1510, the gesture shows a backward motion, the projector 102 identifies that the reception type Sp is an image scale down type, and accordingly generates a control signal Sc.

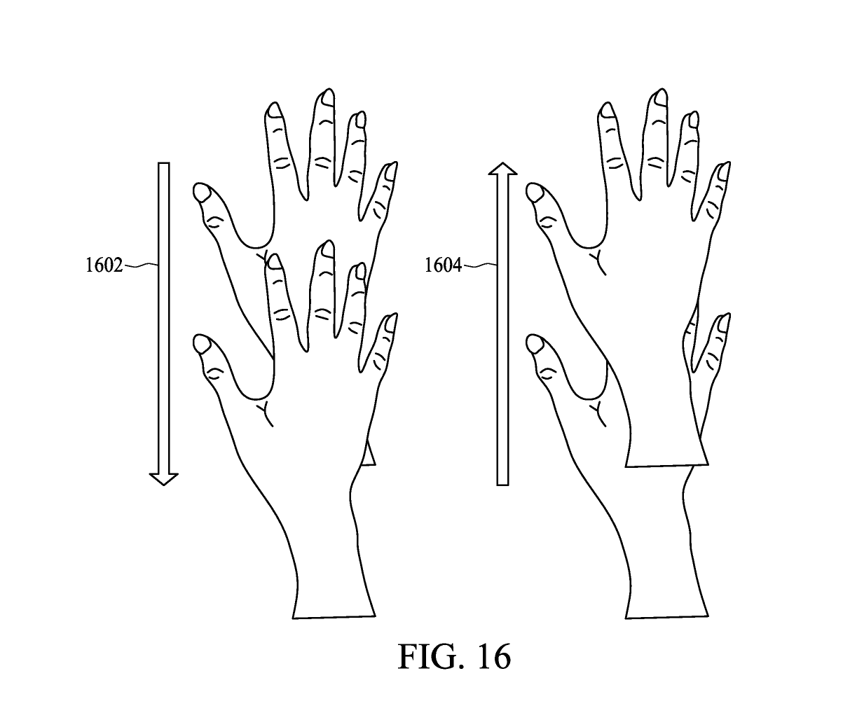

FIG. 16 is a diagram illustrating the gesture of a forward motion and a backward motion according to the present disclosure. Further, according to the gesture shown on the left side of FIG. 16, when the palm is open and moves forward as indicated by the arrow 1602 in FIG. 16, no matter whether the palm faces upward or downward, the projector 102 would enlarge a specific point on the current projection image with a predetermined magnification, and outputs an updated projection image in step S1512. On the contrary, according to the gesture on the right side of FIG. 16, when the palm is open and moves backward as indicated by the arrow 1602 in FIG. 16, the projector 102 would scale down a specific point on the current projection image with a predetermined magnification, and outputs an updated projection image in step S1512.

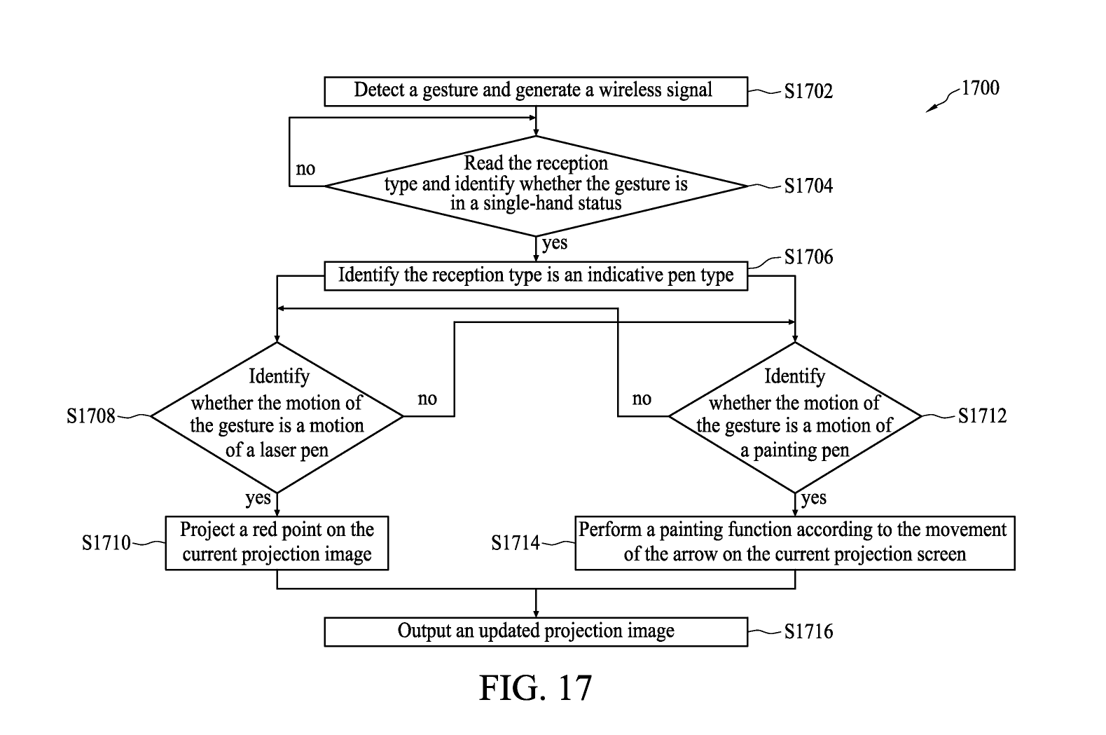

FIG. 17 is a diagram illustrating a projecting system 100 performing an indicative pen operation 1700 according to an embodiment of the present disclosure. Referring FIG. 17, in step S1702, the wireless controller 104 detects a gesture and generates a wireless signal Sr to the projector 102. In step S1704, the projector 102 reads the reception type Sp, and identifies whether the gesture is in a single-hand status. If the gesture is in the single-hand status, step S1706 is performed. If the gesture is not in the single-hand status, step S1704 is performed.

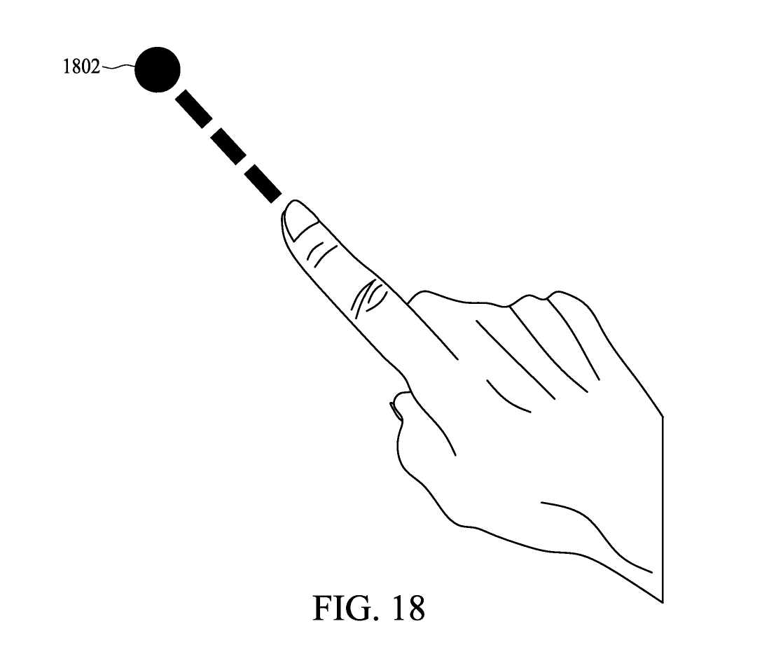

In step S1706, the projector 102 identifies that the reception type Sp is an indicative pen type p6 (i.e. the target type), and thus the projector 102 enters an indicative pen mode. In step S1708, the projector 102 further identifies whether the motion of the gesture is a motion of a laser pen. If the motion of the gesture is a motion of a laser pen, step S1710 is performed. If the motion of the gesture is not a motion of a laser pen, step S1712 is performed. In step S1710, the projector 102 projects a red point on the current projection image, and outputs an updated projection image in step S1716. Please note that the point projected by the projector 102 is not limited to a red point, and a projection point with any color falls within the scope of the present disclosure. In one embodiment, the red point moves along with the arrow which is like that of a real laser pen pointing at a specific potion on the image, as shown in FIG. 18. FIG. 18 is a diagram illustrating the gesture of the motion of a laser pen according to the present disclosure. In addition, in another embodiment, the motion of the gesture is a motion of a laser pen, and if the red point 1802 moves to an App on the current image and stays for more than a specific number of seconds (for example, 2 seconds), the gesture triggers a click to activate the App.

In step S1712, the projector 102 further identifies whether the motion of the gesture is a motion of a painting pen. If the motion of the gesture is a motion of a painting pen, step S1714 is performed. If the motion of the gesture is not a motion of a painting pen, step S1708 is performed. In step S1714, the projector 102 performs a painting function according to the movement of the arrow on the current projection screen, and outputs an updated projection image in step S1716.

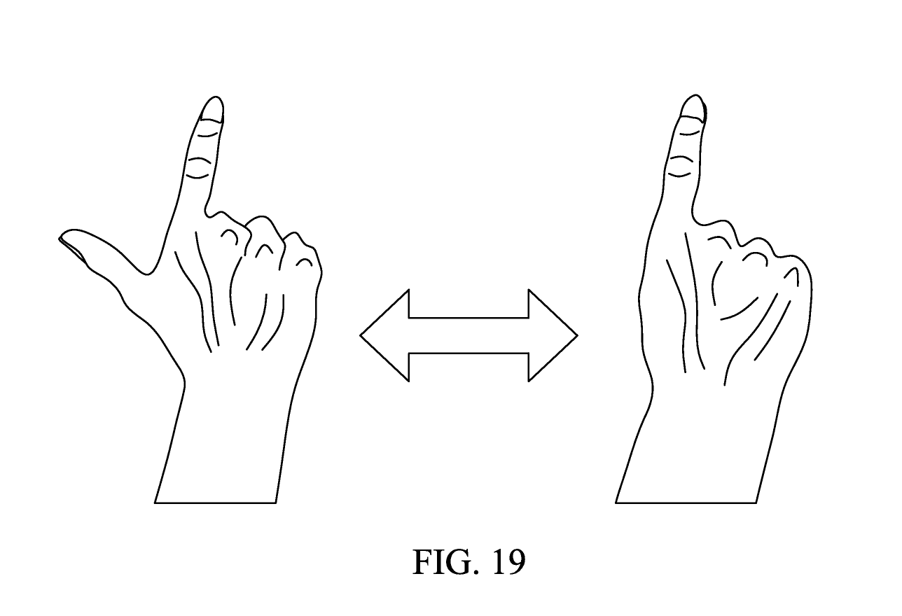

In addition, the projector 102 switches between the motion of the painting pen and the motion of the laser pen according to the changes in the number of fingers of the gesture, as shown in FIG. 19. FIG. 19 is a diagram illustrating the switching between the motion of the painting pen and the motion of the laser pen according to the changes in number of fingers in the present disclosure. In one embodiment, when the number of fingers changes from 1 to 2, the motion of the laser pen is switched to the motion of the painting pen on the current projection image. On the contrary, when the number of fingers changes from 2 to 1, the motion of the painting pen is switched to the motion of the laser pen on the current projection image. Therefore, under the indicative pen mode, the motion of the painting pen and the motion of the laser pen can be switched to each other at any time.

Please note that the above projecting actions can also be controlled by the touch panel 1022 disposed on the projector 102, and the detailed operations are not described herein.

In light of the above embodiments of the present disclosure, when the wireless controller 104 is connected to the projector 102, the wireless controller 104 can wirelessly detect variations of a gesture, and controls the projector 102 to perform at least six different projecting actions, i.e. a clean-handwriting action, a jump page action, a screen adjustment action, a change page action, an image adjustment action and an indicative pen action. Accordingly, a speaker remotely controls a projecting device without holding a remote controller for an extended time, such that the speaker can concentrate on the presentation. In addition, the wireless controller 104 of the present disclosure can be integrated into a conventional remote controller for saving hardware cost of a projecting device.

Although the technical content and technical features of the present disclosure are discloses in the above descriptions, one with ordinary skill in the art would understand substitutions and modifications may be made without departing from the spirit and scope of claims of the present disclosure. For example, many of the above disclosed processing procedures can be substituted by different implementations, other procedures or a combination of any two of the above disclosed processing procedures.

Additionally, the scope of claims of the present application is not limited to the procedures, machines, manufacture, components of matters, devices, methods or steps disclosed in the above embodiments. One with ordinary knowledge in the art of the present disclosure would understand that based on the present disclosure, the current or future developed procedures, machines, manufacture, components of matters, devices, methods or steps, which implement substantially the same functions and achieve substantially the same effects as those of the present disclosure, can be used in the present disclosure. Hence, these procedures, machines, manufacture, components of matters, devices, methods and steps fall within the scope of the following claims.

What is claimed is:

1. A projecting device, comprising:
a wireless controller configured for wirelessly detecting a gesture to generate a wireless signal; and
a projector configured for receiving the wireless signal, and accordingly controlling a projection image projected by the projector.

2. The projecting device of claim 1, wherein the wireless controller comprises:
a sensing unit configured for sensing the gesture and generating a sensing signal;
a first processing unit configured for generating a gesture feature signal according to the sensing signal; and
a wireless signal outputting unit configured for generating the wireless signal according to the gesture feature signal.

3. The projecting device of claim 1, wherein the projector comprises:
a wireless signal receiving unit configured for receiving the wireless signal, and accordingly generating a reception type;
a second processing unit configured for generating a control signal according to the reception type;
a third processing unit configured for generating an updated image signal according to the control signal; and
a projecting unit configured for projecting the projection image according to the updated image signal.

4. The projecting device of claim 3, wherein the second processing unit comprises:
a gesture recognition unit configured for identifying whether the reception type is one of a plurality of predetermined types to generate the control signal; and
a first storage unit configured for storing the plurality of predetermined types,
wherein if the reception type is substantially the same as one target type of the plurality of predetermined types, the gesture recognition unit generates the control signal according to the target type.

5. The projecting device of claim 4, wherein the third processing unit comprises:
an image processing unit configured for performing an image processing operation on a current image signal according to the control signal, and accordingly generating the updated image signal; and
a second storage unit configured for storing at least one temporarily stored signal generated by the image processing unit while performing the image processing operation.

6. The projecting device of claim 3, wherein the second processing unit reads the reception type, and identifies whether a tool is held in the gesture; if the tool is held, the projector enters a clean-handwriting mode; then the second processing unit identifies a number of rotating turns of the tool; if the number of turns reaches a specific number of turns, the second processing unit identifies that the reception type is a clean-all-handwriting type, and accordingly generates the control signal; if the number of turns fails to reach the specific number of turns, the second processing unit identifies that the reception type is a clean-partial-handwriting type, and accordingly generates the control signal.

7. The projecting device of claim 3, wherein the second processing unit reads the reception type, and identifies whether the gesture is in a single-hand status; if the gesture is in the single-hand status, the projector enters a jump page mode; then the second processing unit identifies a motion of the gesture; if the gesture has a downward swing motion and a upward swing motion, the second processing unit detects a number of fingers in the gesture, and accordingly generates the control signal, in which the number of fingers is a number of the jump page.

8. The projecting device of claim 3, wherein the second processing unit reads the reception type, and identifies whether the gesture is in a two-hand status; if the gesture is in the two-hand status, the projector enters a screen adjustment mode; then the second processing unit identifies a motion of the gesture; if the gesture shows a palms-together motion, the second processing unit identifies that the reception type is a screen combination type, and accordingly generates the control signal; if the gesture shows a palms-apart motion, the second processing unit identifies that the reception type is a screen division type, and accordingly generates the control signal; if the gesture shows two fists together and then separate apart, the second processing unit identifies that the reception type is a closing application program type, and accordingly generates the control signal.

9. The projecting device of claim 3, wherein the second processing unit reads the reception type, and identifies whether the gesture is in a single-hand status; if the gesture is in the single-hand status, the projector enters a change page mode; then the second processing unit identifies a motion of the gesture; if the gesture shows a rightward swing motion, the second processing unit identifies that the reception type is a backward change page type, and accordingly generates the control signal; if the gesture shows a leftward swing motion, the second processing unit identifies that the reception type is a forward change type motion, and accordingly generates the control signal.

10. The projecting device of claim 3, wherein the second processing unit reads the reception type, and identifies whether the gesture is in a single-hand status; if the gesture is in the single-hand status, the projector enters an image adjustment mode; then the second processing unit identifies a motion of the gesture; if the gesture shows a forward motion, the second processing unit identifies that the reception type is an image enlarge type, and accordingly generates the control signal; if the gesture shows a backward motion, the second processing unit identifies that the reception type is an image scale down type, and accordingly generates the control signal.

11. The projecting device of claim 3, wherein the second processing unit reads the reception type, and identifies whether the gesture is in a single-finger status; if the gesture is in the single-finger status, the projector enters an indicative pen mode; then the second processing unit identifies that the gesture shows a motion of a painting pen or a motion of a laser pen, accordingly generates the control signal, and further switches between the motion of the painting pen and the motion of the laser pen according to a change of a number of fingers in the gesture.

12. A projecting method, comprising steps of:
(a) wirelessly detecting a gesture and generating a wireless signal; and
(b) controlling a projection image projected by a projector according to the wireless signal.

13. The projecting method of claim 12, wherein the step (b) comprises:
receiving the wireless signal to generate a reception type;
generating a control signal according to the reception type;
generating an updated image signal according to the control signal; and
projecting the projection image according to the updated image signal.

14. The projecting method of claim 13, wherein the step of generating the control signal according to the reception type comprises:
reading the reception type and identifying whether a tool is held in the gesture;
controlling the projector to enter a clean-handwriting mode if the tool is held in the gesture;
identifying a number of rotating turns of the tool;
identifying that the reception type is a clean-all-handwriting type and accordingly generating the control signal if the number of turns reaches a specific number; and
identifying that the reception type is a clean-partial-handwriting and accordingly generating the control signal if the number of turns does not reach the specific number.

15. The projecting method of claim 13, wherein the step of generating the control signal according to the reception type comprises:
reading the reception type and identifying whether the gesture is in a single-hand status;
controlling the projector to enter a jump page mode if the gesture is in the single-hand status;
identifying a motion of the gesture; and
detecting a number of fingers in the gesture and accordingly generating the control signal if the gesture shows a downward swing and an upward swing, wherein the number of fingers indicates a number of the jump page.

16. The projecting method of claim 13, wherein the step of generating the control signal according to the reception type comprises:
reading the reception type and identifying whether the gesture is in a two-hand status;
controlling the projector to enter a screen adjustment mode if the gesture is in the two-hand status;
identifying a motion of the gesture;
identifying that the reception type is a screen combination type and accordingly generating the control signal if the gesture shows a palms-together motion;
identifying that the reception type is a screen division type and accordingly generating the control signal if the gesture shows a palms-apart motion; and
identifying that the reception is a closing application program type and accordingly generating the control signal if the gesture shows two fists together and then separate apart.

17. The projecting method of claim 13, wherein the step of generating the control signal according to the reception type comprises:
reading the reception type and identifying whether the gesture is in a single-hand status;
controlling the projector to enter a change page mode if the gesture is in the single-hand status;
identifying a motion of the gesture;
identifying that the reception type is a backward change page type and accordingly generating the control signal if the gesture shows a rightward swing motion; and
identifying that the reception type is a forward change page type and accordingly generating the control signal if the gesture shows a leftward swing motion.

18. The projecting method of claim 13, wherein the step of generating the control signal according to the reception type comprises:
reading the reception type and identifying whether the gesture is in a single-hand status;
controlling the projector to enter an image adjustment mode if the gesture is in the single-hand status;
identifying a motion of the gesture;
identifying that the reception type is an image enlarge type and accordingly generating the control signal if the gesture shows a forward motion; and
identifying that the reception type is an image scale down type and accordingly generating the control signal if the gesture shows a backward motion.

19. The projecting method of claim 13, wherein the step of generating the control signal according to the reception type comprises:
reading the reception type and identifying whether the gesture is in a single-finger status;
controlling the projector to enter an indicative pen mode if the gesture is in the single-finger status;
identifying whether the gesture shows a motion of a painting pen or a motion of a laser pen, and accordingly generating the control signal; and
switching between the motion of the painting pen and the motion of the laser pen according to a number of fingers in the gesture.

20. A wireless controller, comprising:
a sensing unit configured for wirelessly sensing a gesture and accordingly generating a sensing signal;
a processing unit configured for generating a gesture feature signal according to the sensing signal; and
a wireless signal outputting unit configured for generating a wireless signal according to the gesture feature signal.
